(19) United States
(12) Patent Application Publication
(10) Pub. No.: US 2020/0011680 A1
(43) Pub. Date: Jan. 9, 2020

(54) INFORMATION PROCESSING APPARATUS, INFORMATION PROCESSING METHOD AND NON-TRANSITORY STORAGE MEDIUM

(71) Applicant: TOYOTA JIDOSHA KABUSHIKI KAISHA, Toyota-shi (JP)

(72) Inventors: Akihiko NAKANISHI, Nisshin-shi (JP); Daigo FUJII, Tsushima-shi (JP); Makoto TANAKA, Toyota-shi (JP); Kazuki TAKEUCHI, Toyota-shi (JP); Chie KOIKE, Nagoya-shi (JP); Daiki KANEICHI, Nisshin-shi (JP); Tsuyoshi OKADA, Toyota-shi (JP)

(73) Assignee: TOYOTA JIDOSHA KABUSHIKI KAISHA, Toyota-shi (JP)

(21) Appl. No.: 16/454,241

(22) Filed: Jun. 27, 2019

(30) Foreign Application Priority Data
Jul. 5, 2018 (JP) 2018-128377

(51) Int. Cl. G01C 21/34; G06F 16/9035

(52) U.S. Cl. CPC G01C 21/3438; G06F 16/9035

(57) ABSTRACT

An information processing apparatus according to the present invention sets a provisional combination of users who share the same vehicle when determining a combination of the users sharing the same vehicle and acquires greeting moving images of users included in the set provisional combination. The information processing apparatus transmits greeting moving images of other users included in the provisional combination and information for inquiring whether or not to consent to the provisional combination to terminals of the users included in the provisional combination. Upon receiving information indicating consent to the provisional combination from the terminals of all the users included in the provisional combination, the information processing apparatus sets the provisional combination as an official combination.

### CROSS-REFERENCE TO RELATED APPLICATIONS

This application claims the benefit of Japanese Patent Application No. 2018-128377, filed on Jul. 5, 2018 which is hereby incorporated by reference herein in its entirety.

### BACKGROUND

### Technical Field

The present disclosure relates to an information processing apparatus, an information processing method and a non-transitory storage medium.

### Description of the Related Art

Techniques for determining whether or not owners of terminals are sharing the same vehicle based on position information of the respective terminals and calculating environment loads such as CO₂ emission and fuel consumption based on the determination result are known (for example, see patent literature 1).

### CITATION LIST

### Patent Literature

Patent Literature 1: Japanese Patent Application Laid-Open No. 2011-237842

### SUMMARY

It is an object of the present disclosure to provide a technique capable of contributing, in ride sharing for a plurality of users to share the same vehicle for a traveling purpose, to relieving anxiety of the users when using the ride sharing.

The present disclosure provides an information processing apparatus in a mode in which a plurality of users share the same vehicle, the information processing apparatus determining a combination of users sharing the same vehicle. Such an information processing apparatus is provided with a controller including at least one processor. The controller is configured to execute: setting a provisional combination of users sharing the vehicle; acquiring greeting moving images, which are moving images taken of greeting action of the users included in the provisional combination; transmitting the greeting moving images of other users included in the provisional combination and information for inquiring whether or not to consent to the provisional combination to terminals used by the users included in the provisional combination; and setting, upon receiving the information indicating consent to the provisional combination from the terminals of all the users included in the provisional combination, the provisional combination as an official combination.

Furthermore, the present disclosure can also be perceived as an information processing method in a mode in which a plurality of users share the same vehicle, the information processing method determining a combination of the users sharing the vehicle. In that case, the information processing method according to the present disclosure may be made to cause a computer to execute: a step of setting a provisional combination of users sharing the vehicle; a step of acquiring greeting moving images, which are moving images taken of greeting action of the users included in the provisional combination; a step of transmitting the greeting moving images of other users included in the provisional combination and information for inquiring whether or not to consent to the provisional combination to terminals used by the users included in the provisional combination; and a step of setting, upon receiving the information indicating consent to the provisional combination from the terminals of all the users included in the provisional combination, the provisional combination as an official combination.

Furthermore, the present disclosure can also be perceived as an information processing program or a non-transitory storage medium stored with the information processing program. In case that, the information processing program may be configured to make to cause a computer to determine a combination of the users sharing the vehicle in a mode in which a plurality of users share the same vehicle. For example, the information processing program according to the present disclosure may be made to cause a computer to execute: a step of setting a provisional combination of users sharing the vehicle; a step of acquiring greeting moving images, which are moving images taken of greeting action of the users included in the provisional combination; a step of transmitting the greeting moving images of other users included in the provisional combination and information for inquiring whether or not to consent to the provisional combination to terminals used by the users included in the provisional combination; and a step of setting, upon receiving the information indicating consent to the provisional combination from the terminals of all the users included in the provisional combination, the provisional combination as an official combination.

According to the present disclosure, it is possible to contribute, in ride sharing for a plurality of users to share the same vehicle for a traveling purpose, to relieving anxiety of the users when using the ride sharing.

### BRIEF DESCRIPTION OF DRAWINGS

FIG. 1 is a diagram for describing an overview of ride-sharing;

FIG. 2 is a diagram illustrating a schematic configuration of a ride-sharing system;

FIG. 3 is a diagram illustrating a hardware configuration of a user terminal and a server apparatus;

FIG. 4 is a block diagram illustrating a functional configuration of the server apparatus;

FIG. 5 is a diagram illustrating a configuration example of a reservation information table;

FIG. 6 is a diagram illustrating another configuration example of the reservation information table;

FIG. 7 is a diagram illustrating a configuration example of a member information table;

FIG. 8 is a block diagram illustrating a functional configuration of a user terminal according to the first embodiment;

FIG. 9 is a diagram illustrating an example of a screen for urging a user to take a greeting moving image; and

FIG. 10 is a flowchart illustrating a process executed by the server apparatus when the server apparatus receives request information from the user terminal.

### DESCRIPTION OF EMBODIMENTS

The present disclosure is an information processing apparatus determining, in a mode in which a plurality of users share the same vehicle (ride sharing), a combination of the users sharing the vehicle. In ride sharing, it is expected that users who are unacquainted with each other often share the same vehicle. Therefore, users may feel anxiety about riding in the same vehicle with other unacquainted users. In this respect, there can be a method of presenting to each user, attribute information (gender, age, occupation or the like) and still images of appearances or the like of the other users in advance in determining a combination of users sharing the same vehicle. However, it is difficult to determine the natures of the other users from attribute information and still images of appearances alone, and it is not possible to perceive such determination to be a method effective in relieving anxiety of the users.

Thus, in determining a combination of users who share the same vehicle, a controller of the information processing apparatus according to the present disclosure sets a provisional combination of users who ride in the same vehicle and acquires greeting moving images of the users included in the provisional combination. Next, the controller transmits the greeting moving images of the other users included in the provisional combination and information for inquiring whether or not to consent to the provisional combination to terminals used by the users included in the provisional combination. Upon receiving information indicating consent to the provisional combination from the terminals of all the users included in the provisional combination, the controller sets the provisional combination as an official combination.

According to the information processing apparatus according to the present disclosure, each user included in the provisional combination can determine whether or not to consent to ride sharing in the same vehicle according to the provisional combination with reference to the greeting moving images of the other users. In that case, the user can use not solely appearances of the other users but also a manner of speaking or behavior or the like as reference, and can thereby determine the natures of the other users more easily compared to a case where the user uses attribute information and still images of the appearances as reference. It is thereby possible to relieve anxiety felt by the users when using ride sharing.

Note that when it is not possible to receive information indicating consent to the provisional combination from the terminals of all the users included in the provisional combination, or in other words, upon receiving information indicating no consent to the provisional combination from terminals of at least one user included in the provisional combination, the controller may set a new provisional combination of users, which is a combination composed of users different from the provisional combination. It is thereby possible to prevent ride sharing from being carried out in a combination undesirable to the users.

Here, the above greeting moving images may be acquired by storing greeting moving images provided by the users in advance (e.g., a greeting moving image provided by a user when the user applies for membership registration for a ride-sharing service) in a storage unit or the like of the information processing apparatus and reading the greeting moving images from the storage unit when the above provisional combination is set. However, when a time elapses after the photographing timing of the greeting moving image, an appearance of the user may change, and so it may be preferable to acquire a greeting moving image photographed immediately before. In that case, for example, after the provisional combination is set, the controller may acquire the greeting moving images by requesting the terminals of the users included in the provisional combination to take and transmit the greeting moving images. Accordingly, each user included in the provisional combination can determine whether or not to consent to ride sharing in the same vehicle by the above provisional combination with reference to the greeting moving images of the other users taken after setting the provisional combination.

Hereinafter, specific embodiments of the present disclosure will be described based on the accompanying drawings. Dimensions, materials, shapes, and other relative arrangements or the like of components described in the present embodiments are not intended to limit the technical scope of the present disclosure to those embodiments unless specified otherwise.

### EMBODIMENT

An example will be described in the present embodiment where the present disclosure is implemented in a mode in which a plurality of users intended for traveling share the same vehicle (hereinafter referred to as “ride-sharing”). Note that automobiles and trains or the like can be used as vehicles that can be shared among a plurality of users for a traveling purpose. A case will be described in the present embodiment where an automobile is used as an example of such vehicles.

(Overview of Ride-Sharing)

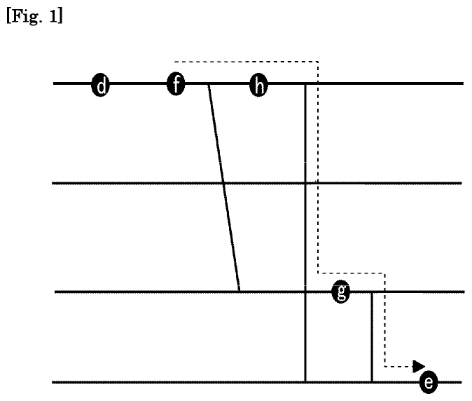

First, an overview of ride-sharing will be described based on FIG. 1. In an example shown in FIG. 1, suppose that a user A travels from a starting point d to a destination point e, a user B travels from a starting point f to a destination point g and a user C travels from a starting point h to the destination point e.

Here, if the users A to C travel separately in their respective vehicles, three vehicles are necessary. In contrast, if the users A to C share the same vehicle, the users A to C can travel to their respective destinations in one vehicle. In the example shown in FIG. 1, the user A himself/herself drives a vehicle and travels from the point d to the point e. At this time, the user A allows the user B to get in the vehicle driven by the user A at the point f, and allows the user C to get in the vehicle driven by the user A at the point h. On the way to the point e which is the destination of the user A and the user C, the user A travels via the point g, where the user B gets off the vehicle, thus allowing the user B to travel from the starting point f to the destination point g. After that, the user A drives the vehicle from the point g to the point e to thereby allow the user C to travel from the starting point h to the destination point e, and at the same time the user A himself/herself can attain the traveling of the user A.

Such ride-sharing can reduce the number of vehicles traveling on a road, and can thereby relax traffic jam. Furthermore, since a plurality of users who share the same vehicle share transportation expenses (fuel expenses or the like) necessary for traveling in the vehicle, it is possible to cut down on a transportation cost per user compared to a case where each user travels in an individual vehicle.

Note that the aspect of ride-sharing shown in FIG. 1 is merely an example, and combinations of users who share one vehicle can be determined using well-known techniques.

Here, in the aforementioned ride-sharing, unacquainted users may share the same vehicle. In that case, there can be users who may feel anxiety about sharing the same vehicle with other unacquainted users. Therefore, in the present embodiment, at a point in time at which a provisional combination of users who ride in the same vehicle is set, greeting moving images of other users are provided to each user included in the provisional combination to inquire each user about whether or not to consent to the provisional combination. Accordingly, each user included in the provisional combination uses the greeting moving images of the other users included in the provisional combination as reference, and can thereby more easily grasp the natures of the other users, and can thereby more easily determine whether or not to consent to ride sharing in the same vehicle according to the above provisional combination.

(System Configuration)

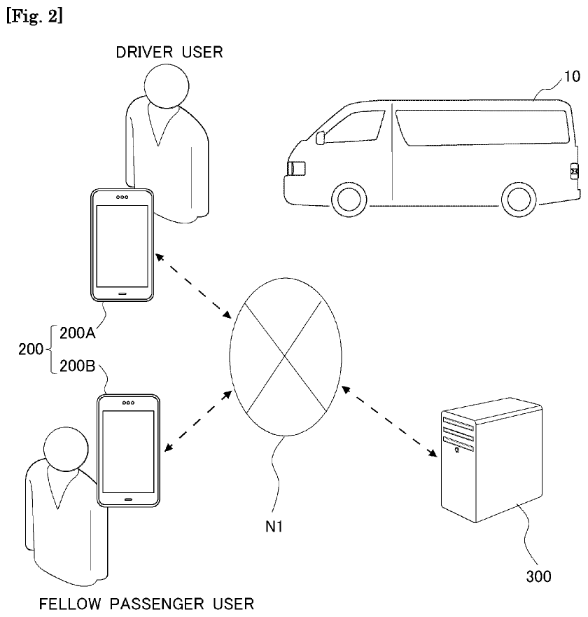

FIG. 2 is a diagram illustrating a configuration example of a system for providing a ride-sharing service (hereinafter may also be referred to as a “ride-sharing system”). In the example shown in FIG. 2, the ride-sharing system is constructed of a vehicle 10 used for ride sharing, a user terminal 200 used by a user sharing the vehicle 10 and a server apparatus 300. The user terminal 200 and the server apparatus 300 are mutually connectable via a network N1. A WAN (Wide Area Network) which is a worldwide public communication network such as the Internet or other communication networks may be adopted for the network N1. The network N1 may include a telephone communication network such as mobile phones or a wireless communication network such as WiFi.

Note that although only one vehicle 10 is illustrated in the example shown in FIG. 2 as the vehicle available for the ride-sharing service, suppose that the ride-sharing system includes a number of vehicles registered as vehicles available for the ride-sharing service. In the example in FIG. 2, just two terminals are illustrated as the user terminal 200: a user terminal 200A (hereinafter referred to as a “first user terminal 200A”) used by a user who drives a vehicle 10 used for ride sharing (hereinafter referred to as a “driver user”) and a user terminal 200B (hereinafter referred to as a “second user terminal 200B”) used by a user who rides in the same vehicle 10 driven by the driver user other than oneself (hereinafter referred to as a “fellow passenger user”), but suppose that the ride-sharing system includes a number of user terminals corresponding to the number of users registered as members entitled to use the ride-sharing service.

A predetermined application for using a ride-sharing service is installed in each user terminal 200. The user of the user terminal 200 causes the own user terminal 200 to execute the above predetermined application, and can thereby register information relating to conditions or the like when sharing a vehicle (hereinafter may also be referred to as “request information”) in the server apparatus 300. For example, the driver user causes the first user terminal 200A to execute the above predetermined application, and can thereby register information relating to their own planned traveling period and traveling date and time or the like in the vehicle 10 in the server apparatus 300 as request information. On the other hand, the fellow passenger user causes the second user terminal 200B to execute the above predetermined application, and can thereby register information relating to their own desired ride sharing period and ride sharing date and time or the like in the server apparatus 300 as request information. Note that details of the user terminal 200 will be described later.

The server apparatus 300 receives the request information from the driver user and the request information from the fellow passenger user. The server apparatus 300 determines a provisional combination of a driver user and a fellow passenger user based on the request information from the driver user and the request information from the fellow passenger user. In that case, the number of users sharing the same vehicle combined with one driver user need not be one, but may be plural. The server apparatus 300 acquires respective greeting moving images of the driver user and fellow passenger users included in the above provisional combination and transmits information for inquiring whether or not to consent to the acquired greeting moving images and the above provisional combination to the user terminal 200 of each user. The greeting moving images referred to here are moving images taken of greeting action of the users. Note that a method of acquiring the greeting moving images will be described later. Upon receiving the information indicating consent to the above provisional combination from the respective user terminals 200A and 200B of the driver user and the fellow passenger users for the above inquiry, the server apparatus 300 determines the above provisional combination as an official combination. Hereinafter, a process for the server apparatus 300 to confirm a combination of a driver user and a fellow passenger user using the above procedure will be referred to as a “matching process.” Note that according to the present embodiment, the server apparatus 300 that performs the above matching process corresponds to an “information processing apparatus” according to the present disclosure.

(Hardware Configuration)

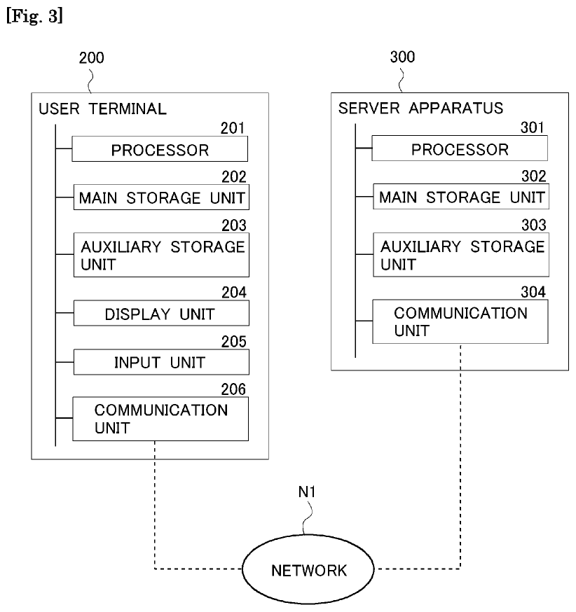

FIG. 3 is a diagram illustrating a hardware configuration of each of the user terminal 200 and the server apparatus 300. Note that the first user terminal 200A and the second user terminal 200B shown in aforementioned FIG. 2 each have a hardware configuration similar to the configuration of the user terminal 200 in FIG. 3.

The server apparatus 300 has a configuration of a general computer. That is, the server apparatus 300 includes a processor 301, a main storage unit 302, an auxiliary storage unit 303 and a communication unit 304. These components are mutually connected via a bus. The main storage unit 302 and the auxiliary storage unit 303 are computer-readable storage media. The hardware configuration of the computer is not limited to the configuration example shown in FIG. 3, but components may be omitted, replaced or added as appropriate.

The server apparatus 300 implements functions matching to a predetermined object by the processor 301 loading a work region of the main storage unit 302 with a program stored in the storage medium and executing the program, and controlling the respective function components through execution of the program.

The processor 301 is, for example, a CPU (Central Processing Unit) or a DSP (Digital Signal Processor). The processor 301 controls the server apparatus 300 and performs operations of various kinds of information processing. The main storage unit 302 includes, for example, a RAM (Random Access Memory) and a ROM (Read Only Memory). The auxiliary storage unit 303 is, for example, an EPROM (Erasable Programmable ROM) or a hard disk drive (HDD). Furthermore, the auxiliary storage unit 303 can include a removable medium, that is, a removable storage medium. The removable medium is a disk storage medium such as a USB (Universal Serial Bus) memory, a CD (Compact Disc) or a DVD (Digital Versatile Disc).

The auxiliary storage unit 303 stores various programs, various kinds of data and various tables in a storage medium in a freely readable/writable state. The auxiliary storage unit 303 stores an operating system (OS), various programs and various tables or the like. Note that a part or a whole of these pieces of information may also be stored in the main storage unit 302. Information stored in the main storage unit 302 may be stored in the auxiliary storage unit 303.

The communication unit 304 transmits/receives information between an external apparatus and the server apparatus 300. The communication unit 304 is, for example, a LAN (Local Area Network) interface board or a wireless communication circuit for wireless communication. The LAN interface board or wireless communication circuit is connected to a network N1.

A series of processes executed by the server apparatus 300 configured as described above may be executed by hardware or may also executed by software.

Next, the user terminal 200 is a small computer that can be carried by the user such as a smartphone, a mobile phone, a tablet terminal, a personal information terminal, a wearable computer (smart watch or the like). Note that the user terminal 200 may also be a personal computer (PC) connected to the server apparatus 300 via the network N1 such as the Internet which is a public communication network.

The user terminal 200 includes a processor 201, a main storage unit 202, an auxiliary storage unit 203, a display unit 204, an input unit 205 and a communication unit 206. Since the processor 201, the main storage unit 202 and the auxiliary storage unit 203 are similar to the processor 301, the main storage unit 302 and the auxiliary storage unit 303 of the server apparatus 300, description thereof is omitted. The display unit 204 is, for example, an LCD (Liquid Crystal Display) or an EL (Electroluminescence) panel. The input unit 205 includes, for example, a touch panel that allows symbols such as characters to be inputted, push buttons, a microphone that allows voice to be inputted or a camera that allows a moving image or still image to be picked up. The communication unit 206 is a communication circuit for accessing the network N1 using, for example, a mobile communication service (telephone communication network such as a mobile phone or wireless communication of WiFi or the like) and carrying out data communication with the server apparatus 300 or the like.

(Functional Configuration of Server Apparatus)

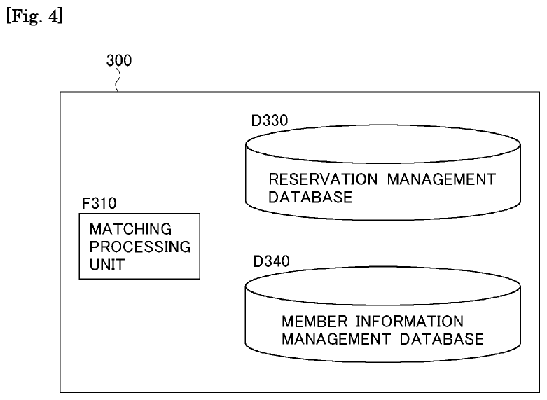

Here, a functional configuration of the server apparatus 300 will be described based on FIG. 4. As shown in FIG. 4, the server apparatus 300 of the present embodiment includes, as functional components thereof, a matching processing unit F310, a reservation management database D330 and a member information management database D340. Here, the matching processing unit F310 is formed by the processor 301 of the server apparatus 300 executing a computer program in the main storage unit 302. Note that part of the matching processing unit F310 may be formed of a hardware circuit.

The reservation management database D330 and a member information management database D340 are constructed by a program of a database management system (DBMS) executed by the processor 301 of the server apparatus 300 managing data stored in the auxiliary storage unit 303. These reservation management database D330 and member information management database D340 are, for example, relational databases.

Note that any one or part of processing thereof of the respective functional components of the server apparatus 300 may be executed by another computer connected to the network N1. For example, part of process included in the matching processing unit F310 may be executed by other computers.

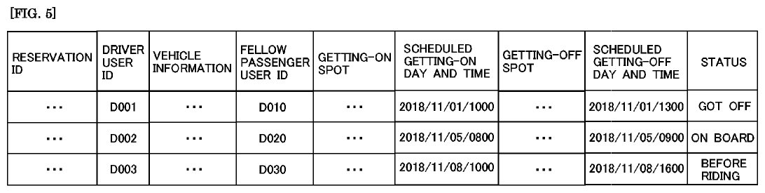

The reservation management database D330 stores reservation information for a ride-sharing service, where information relating to the driver user is associated with information relating to a fellow passenger user scheduled to share the vehicle 10 driven by the driver user. Here, one configuration example of reservation information stored in the reservation management database D330 will be described based on FIG. 5. FIG. 5 is a diagram illustrating a table configuration of reservation information. Note that information registered in the reservation information table is not limited to the example shown in FIG. 5, but fields can be added, changed or deleted as appropriate.

The reservation information table shown in FIG. 5 includes fields such as a reservation ID, a driver user ID, a vehicle information, a fellow passenger user ID, a getting-on spot, a scheduled getting-on date and time, a getting-off spot, a scheduled getting-off date and time, and a status. A reservation ID which is information for identifying individual reservation information is registered in the reservation ID field. This reservation ID is used when each user confirms or changes reservation contents and is assigned when a combination of users who ride in the same vehicle 10 is officially confirmed. A user ID of a driver user driving the vehicle 10 used for ride sharing is registered in the driver user ID field. Information necessary for a fellow passenger user scheduled to share the vehicle 10 to identify the vehicle 10 driven by each driver user is registered in the vehicle information field. For example, information such as vehicle model, automobile registration number (number displayed on the number plate), vehicle body color or the like is registered in the vehicle information field. A user ID of a fellow passenger user scheduled to share the vehicle 10 driven by each driver user is registered in the fellow passenger user ID field. Information indicating a place where a fellow passenger user is allowed to get on the vehicle 10 driven by each driver user (getting-on spot) is registered in the getting-on spot field. Information indicating a scheduled date and time at which a fellow passenger user is allowed to get on the vehicle 10 driven by each driver user at the above getting-on spot is registered in the scheduled getting-on date and time field. Information indicating a place where a fellow passenger user is allowed to get off the vehicle 10 driven by each driver user (getting-off spot) is registered in the getting-off spot field. Information indicating a scheduled date and time at which a fellow passenger user is allowed to get off the vehicle 10 driven by each driver user at the above getting-off spot is registered in the scheduled getting-off date and time field. Information indicating a ride sharing situation of each vehicle 10 is registered in the status field. For example, the status is registered as “already got off” when the fellow passenger user has already got off the vehicle 10 at the above getting-off spot, the status is registered as “getting on” when the fellow passenger user is sharing the vehicle 10 and the status is registered as “before getting on” in a stage before the fellow passenger user gets on the vehicle 10.

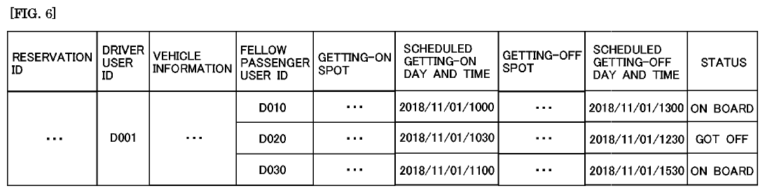

Note that the reservation information table in FIG. 5 corresponds to a table configuration example when one fellow passenger user shares the vehicle 10 driven by each driver user, but the number of fellow passenger users who share the vehicle 10 driven by each driver user may be two or more. In that case, as shown in FIG. 6, one driver user ID may be associated with information of a plurality of fellow passenger users.

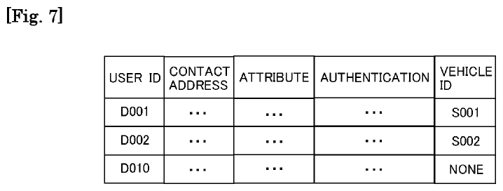

The member information management database D340 stores information on users registered as members in the ride-sharing service (member information). Here, one configuration example of member information stored in the member information management database D340 will be described based on FIG. 7. FIG. 7 is a diagram illustrating a table configuration of member information. Note that information registered in the member information table is not limited to the example shown in FIG. 7, but fields can be added, changed or deleted as appropriate.

The member information table shown in FIG. 7 includes fields such as a user ID, a contact address, an attribute, authentication and a vehicle ID. A user ID assigned when each user applies for member registration for a ride-sharing service is registered in the user ID field. Information indicating a contact address of each user (electronic mail address, telephone number, or the like, including at least an electronic mail address of the user terminal 200 used by each user) is registered in the contact field. Information indicating an attribute of each user (e.g., name, nickname, age, gender, occupation, work place (school), hobby, skill or the like) is registered in the attribute field. Information indicating a password or the like necessary for authentication when the aforementioned request information is registered in the server apparatus 300 or when the aforementioned reservation information is confirmed is registered in the authentication field. A vehicle ID of the vehicle 10 available to each user for ride sharing is registered in the vehicle ID field. Note that, for example, “None” is registered in the vehicle ID field for a user not possessing the vehicle 10 available for ride sharing.

Next, the matching processing unit F310 performs a matching process based on request information from a driver user or a fellow passenger user. More specifically, when the server apparatus 300 receives request information transmitted from the first user terminal 200A of the driver user, the matching processing unit F310 generates a traveling schedule of the vehicle 10 driven by the driver user (e.g., information including a place of departure, a scheduled date and time of departure, a destination, a scheduled date and time of arrival) based on the request information. Furthermore, when the server apparatus 300 receives the request information transmitted from the second user terminal 200B of a fellow passenger user, the matching processing unit F310 generates a desired movement schedule of the shared vehicle (e.g., information including a desired getting-on spot, a desired getting-on date and time, a desired getting-off spot, a desired getting-off date and time) based on the request information. The matching processing unit F310 compares a traveling schedule of each driver user with a movement schedule of each fellow passenger user and extracts a traveling schedule suitable for the movement schedule of the fellow passenger user. For example, the matching processing unit F310 extracts a traveling schedule according to which the place of departure and destination of the fellow passenger user are located on a traveling route of the vehicle 10 driven by the driver user and a movement date and time of the fellow passenger user coincides with the traveling date and time of the vehicle 10 driven by the driver user. Next, the matching processing unit F310 provisionally combines the driver user associated with the extracted traveling schedule and the above fellow passenger user.

Note that the method for the matching processing unit F310 to set a provisional combination is not limited to the above method but the matching process may be performed by other methods using known techniques.

Once the provisional combination between the driver user and the fellow passenger users is set, the matching processing unit F310 acquires greeting moving images of the driver user and the fellow passenger users included in the above provisional combination. For example, the matching processing unit F310 extracts electronic mail addresses of the user terminals 200A and 200B of the respective users from a member information table corresponding to the driver user and the fellow passenger users included in the above provisional combination. Next, the matching processing unit F310 transmits information for requesting photographing and transmission of a greeting moving image to the electronic mail addresses of the respective user terminals 200A and 200B. When the server apparatus 300 receives the greeting moving images transmitted from the respective user terminals 200A and 200B of the driver user and the fellow passenger users in response to this, the matching processing unit F310 transmits the greeting moving images of the other users included in the above provisional combination and information for inquiring whether or not to consent to the above provisional combination to the respective user terminals 200A and 200B of the driver user and the fellow passenger users included in the above provisional combination. In that case, the greeting moving images of the fellow passenger users are transmitted to the first user terminal 200A of the driver user, and on the other hand, the greeting moving image of the driver user is transmitted to the second user terminals 200B of the fellow passenger users. Note that when there are a plurality of fellow passenger users, the greeting moving images of the other fellow passenger users in addition to the greeting moving image of the driver user are transmitted to the second user terminals 200B of the respective fellow passenger users. The information for inquiring whether or not to consent to the above provisional combination includes information indicating ride sharing conditions according to the above provisional combination (e.g., getting-on spot of each fellow passenger user, scheduled getting-on date and time of each fellow passenger user, getting-off spot of each fellow passenger user, scheduled getting-off date and time of each fellow passenger user, type of the vehicle 10, attribute of the driver user, attribute of each fellow passenger user).

When information indicating consent to the above provisional combination is sent back from the respective user terminals 200A and 200B of the driver user and the fellow passenger users included in the above provisional combination to the server apparatus 300, the matching processing unit F310 confirms the above provisional combination as an official combination. Accordingly, the matching processing unit F310 generates a reservation information table as shown in aforementioned FIG. 5 and FIG. 6 based on the above official combination, and stores the generated reservation information table in the reservation management database D330. Note that when it is not possible to receive the information indicating consent to the above provisional combination from the respective user terminals 200A and 200B of the driver user and the fellow passenger users (when information indicating no consent to the above provisional combination is received from at least one user terminal 200 of the driver user and the fellow passenger users included in the above provisional combination), the matching processing unit F310 performs the matching process over again by setting a new provisional combination of users, which is a combination composed of users different from the above provisional combination.

(Functional Configuration of User Terminal)

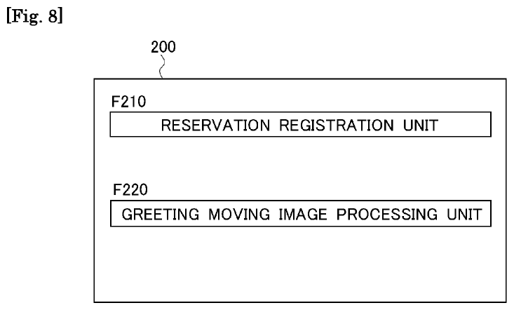

FIG. 8 is a diagram illustrating a functional configuration of the user terminal 200. The user terminal 200 is provided with a reservation registration unit F210 and a greeting moving image processing unit F220 as functional components. These reservation registration unit F210 and greeting moving image processing unit F220 are formed by the processor 201 of the user terminal 200 executing a computer program in the main storage unit 202. Note that any one of the above functional components or part of the processing thereof may be executed by a hardware circuit.

The reservation registration unit F210 receives an input of request information to the input unit 205 from the user and transmits the inputted request information to the server apparatus 300. When the greeting moving images of the other users included in the provisional combination and information for inquiring whether or not to consent to the provisional combination are transmitted from the server apparatus 300 to the user terminals 200 in the form of a reply to the above request information, the reservation registration unit F210 displays information indicating ride sharing conditions according to the above provisional combination and the greeting moving images of the other users included in the above provisional combination on the display unit 204. In that case, the reservation registration unit F210 performs a process of urging the user to select whether or not to accept the ride sharing conditions according to above provisional combination (e.g., a process of displaying a button for selecting whether or not to accept the ride sharing conditions according to the above provisional combination on the input unit 205 such as a touch panel). When the user selects to accept the ride sharing conditions according to the above provisional combination, the reservation registration unit F210 transmits information indicating consent to the above provisional combination to the server apparatus 300. When such information is transmitted from the user terminals 200 of all the users included in the above provisional combination to the server apparatus 300, the above provisional combination is confirmed as an official combination through a matching process of the server apparatus 300 as described above. Accordingly, reservation information corresponding to an official combination is transmitted from the server apparatus 300 to the user terminal 200. In that case, the reservation registration unit F210 displays the reservation information on the display unit 204. This allows the user of the user terminal 200 to confirm the reservation information. Note that the above function of the reservation registration unit F210 is implemented by the above predetermined application.

Here, the method for each user to have the above request information registered in the server apparatus 300 is not limited to the method using the user terminal 200. For example, the above request information may also be registered in the server apparatus 300 using an arbitrary terminal connectable to the network N1 (smartphone, mobile phone, tablet terminal, personal information terminal, wearable computer or the like) or a personal computer (PC).

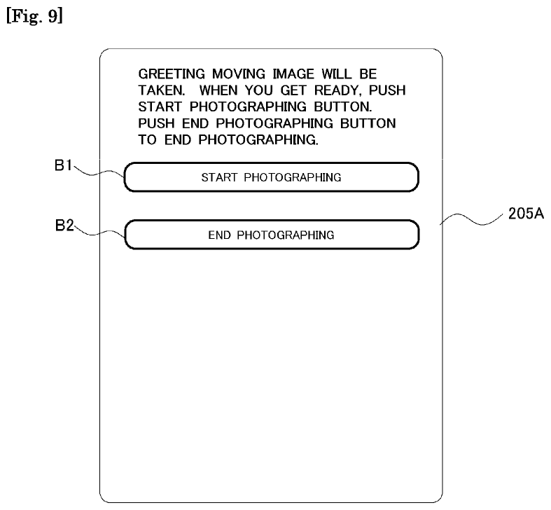

The greeting moving image processing unit F220 performs a process of urging the user to take a greeting moving image. More specifically, when the user terminal 200 receives information for requesting photographing and transmission of the greeting moving image transmitted from the server apparatus 300, the greeting moving image processing unit F220 causes a screen as illustrated in FIG. 9 to be displayed on the touch panel 250A provided for the input unit 205. FIG. 9 is an example of a screen for urging the user to take a greeting moving image. In the example illustrated in FIG. 9, a button B1 for selecting “start photographing” and a button B2 for selecting “end photographing” are displayed on the touch panel 250A and character information for urging photographing of the greeting moving image by operating the two buttons B1 and B2 is displayed. When the user operates the button B1 on the screen illustrated in FIG. 9, the greeting moving image processing unit F220 operates a camera of the input unit 205 to thereby start moving image photographing of the greeting action of the user. After that, when the user operates the button B2, the moving image processing unit ends moving image photographing using the camera of the input unit 205. The greeting moving image taken by the camera is transmitted to the server apparatus 300.

Note that the above function by the greeting moving image processing unit F220 is implemented by the above predetermined application.

(Processing Flow)

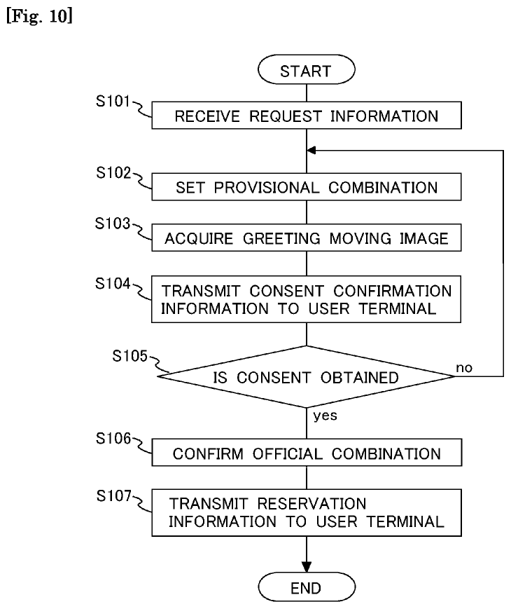

Here, contents of a process executed by the server apparatus 300 in the ride-sharing system according to the present embodiment will be described. FIG. 10 is a flowchart illustrating the process executed by the server apparatus 300 when the request information is received by the server apparatus 300 from the user terminal 200.

In FIG. 10, when request information transmitted from the user terminal 200 is received by the server apparatus 300 (step S101), the matching processing unit F310 of the server apparatus 300 sets a provisional combination between the driver user and the fellow passenger user based on the request information. In that case, when the request information received in step S101 is transmitted from the second user terminal 200B used by the fellow passenger user, the matching processing unit F310 extracts a traveling schedule suitable for the movement schedule of the fellow passenger user and provisionally combines the driver user associated with the extracted traveling schedule and the fellow passenger user. When the request information received in step S101 is from the first user terminal 200A used by the driver user, the matching processing unit F310 extracts a movement schedule suitable for the traveling schedule of the vehicle 10 driven by the driver user and provisionally combines the fellow passenger user associated with the extracted movement schedule and the driver user.

When the provisional combination between the driver user and the fellow passenger user is set in above step S102, the matching processing unit F310 acquires the greeting moving images of the driver user and the fellow passenger user included in the above provisional combination (step S103). More specifically, the matching processing unit F310 transmits information for requesting photographing and transmission of greeting moving images to the respective user terminals 200A and 200B of the driver user and the fellow passenger user included in the provisional combination as described above. After that, the server apparatus 300 receives the greeting moving images transmitted from the respective user terminals 200A and 200B in the form of a reply to such a request, and thereby acquires the greeting moving images of the driver user and the fellow passenger user included in the provisional combination.

When the greeting moving images of the driver user and the fellow passenger user included in the above provisional combination are acquired in above step S103, the matching processing unit F310 transmits information (consent confirmation information) including the greeting moving images of the other users included in the provisional combination and information for inquiring whether or not to consent to the above provisional combination to the respective user terminals 200A and 200B of the driver user and the fellow passenger user included in the provisional combination (step S104). In the user terminal 200 that receives such consent confirmation information, the greeting moving images of the other users are displayed on the display unit 204 in addition to the ride sharing conditions according to the provisional combination. Thus, the user of the user terminal 200 can determine whether or not to consent to the provisional combination using the greeting moving images of the other users taken immediately before as reference. As a result, it is possible to relieve anxiety when the user shares the same vehicle 10 with other unacquainted users.

When the server apparatus 300 receives information transmitted from the respective user terminals 200 of the driver user and the fellow passenger users included in the provisional combination in the form of a reply to the above consent confirmation information, the matching processing unit F310 determines whether or not consent to the provisional combination are obtained from the driver user and the fellow passenger users (step S105). In that case, when information indicating consent to the provisional combination is received from all the user terminals 200 of the driver user and the fellow passenger users included in the provisional combination, this means that consent to the above provisional combination are obtained from the driver user and the fellow passenger users (affirmative determination in step S105), and so the matching processing unit F310 confirms the above provisional combination as an official combination (step S106). The matching processing unit F310 then generates reservation information corresponding to the official combination and transmits the generated reservation information to the respective user terminals 200A and 200B of the driver user and the fellow passenger users included in the official combination (step S107). The matching processing unit F310 generates a reservation information table in which the above reservation information is registered and stores the generated reservation information table in the reservation management database D330.

When no consent to the above provisional combination is obtained from the driver user and the fellow passenger users, that is, it is not possible to receive the information indicating consent to the provisional combination from all the user terminals 200 of the driver user and the fellow passenger users included in the above provisional combination (negative determination in step S105), the matching processing unit F310 returns to aforementioned step S102 and executes the matching process over again. In that case, the matching processing unit F310 sets a new provisional combination of users, which is a combination composed of users different from the provisional combination. This prevents ride sharing from being performed in a combination undesirable to the users.

According to the above processing flow, when a provisional combination of users who share the same vehicle is set, the greeting moving images of the other users included in the provisional combination are transmitted to the user terminals 200 of the respective users and so the respective users included in the provisional combination can determine whether or not to consent to ride sharing in the same vehicle according to the above provisional combination using the greeting moving images of the other users as reference. In that case, each user can use not just appearances of the other users but also a manner of speaking or behavior or the like as reference, and can thereby determine the natures of the other users more easily compared to a case where the user uses attribute information and still images of the appearance as reference. It is thereby possible to relieve anxiety when each user uses ride sharing. Furthermore, when the user does not want to ride in the same vehicle 10 with the other users included in the provisional combination, the user may cause the user terminal 200 to transmit information indicating that the user does not consent to the provisional combination to the server apparatus 300, and can thereby ride in the same vehicle in a combination different from the provisional combination.

<Modification>

An example has been described in the aforementioned embodiment where greeting moving images are acquired, which have been taken after setting a provisional combination between the driver user and the fellow passenger user, but greeting moving images may also be acquired, which have been taken when transmitting request information from each user terminal 200 to the server apparatus 300. In that case, upon receiving an input of request information by the user, the user terminal 200 may urge the user to take a greeting moving image by displaying the aforementioned screen illustrated in FIG. 9 on the touch panel 250A of the input unit 205. Each user terminal 200 may attach the above greeting moving image to the request information when transmitting the request information to the server apparatus 300.

<Others>

The above embodiments are merely examples and the present disclosure can be changed and implemented as appropriate without departing from the spirit and scope of range of the present disclosure.

The processes and configurations described in the present disclosure may be freely combined and implemented unless there are technical inconsistencies. A process described as being performed by one device may be shared and executed among a plurality of devices. Alternatively, processes described as being executed by different devices may be executed by one device. In a computer system, it is possible to flexibly change a hardware configuration used to implement each function.

Furthermore, the present disclosure can also be implemented by supplying a computer program including the functions described in the above embodiments to a computer and by one or more processors included in the computer reading and executing the program. Such a computer program may be supplied to the computer through a non-transitory computer readable storage medium which is connectable to a system bus of the computer or may be supplied to the computer via a network. The non-transitory computer readable storage medium is a storage medium which allows information such as data or a program to be stored through electrical, magnetic, optical, mechanical or chemical action and read from the computer or the like, and examples of such a medium include any type of disk such as magnetic disk (floppy (registered trademark) disk, hard disk drive (HDD) or the like), optical disk (CD-ROM, DVD disk, blue-ray disk or the like), read-only memory (ROM), random access memory (RAM), EPROM, EEPROM, magnetic card, flash memory, optical card and SSD (Solid State Drive).

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. An information processing apparatus in a mode in which a plurality of users share a same vehicle, the information processing apparatus determining a combination of users sharing the same vehicle and comprising a controller including at least one processor,
the controller configured to execute:
setting a provisional combination of the users sharing the vehicle;
acquiring greeting moving images which are moving images taken of greeting action of the users included in the provisional combination;
transmitting the greeting moving images of other users included in the provisional combination and information for inquiring whether or not to consent to the provisional combination to terminals used by the users included in the provisional combination; and
setting, upon receiving the information indicating consent to the provisional combination from the terminals of all the users included in the provisional combination, the provisional combination as an official combination.

2. The information processing apparatus according to claim 1, wherein when it is not possible to receive information indicating consent to the provisional combination from the terminals of all the users included in the provisional combination, the controller sets a new provisional combination of users, which is a combination composed of users different from the provisional combination.

3. The information processing apparatus according to claim 1, wherein after the provisional combination is set, the controller acquires the greeting moving images by requesting the terminals of the users included in the provisional combination to take and transmit the greeting moving images.

4. The information processing apparatus according to claim 2, wherein after the provisional combination is set, the controller acquires the greeting moving images by requesting the terminals of the users included in the provisional combination to take and transmit the greeting moving images.

5. An information processing method in a mode in which a plurality of users share a same vehicle, the information processing method determining a combination of the users sharing the same vehicle by causing a computer to execute:
a step of setting a provisional combination of users sharing the vehicle;
a step of acquiring greeting moving images, which are moving images taken of greeting action of the users included in the provisional combination;
a step of transmitting the greeting moving images of other users included in the provisional combination and information for inquiring whether or not to consent to the provisional combination to terminals used by the users included in the provisional combination; and
a step of setting, upon receiving information indicating consent to the provisional combination from the terminals of all the users included in the provisional combination, the provisional combination as an official combination.

6. A non-transitory storage medium stored with an information processing program in a mode in which a plurality of users share a same vehicle, the information processing program determining a combination of the users sharing the same vehicle by causing a computer to execute:
a step of setting a provisional combination of users sharing the vehicle;
a step of acquiring greeting moving images, which are moving images taken of greeting action of the users included in the provisional combination;
a step of transmitting the greeting moving images of other users included in the provisional combination and information for inquiring whether or not to consent to the provisional combination to terminals used by the users included in the provisional combination; and
a step of setting, upon receiving information indicating consent to the provisional combination from the terminals of all the users included in the provisional combination, the provisional combination as an official combination.
